(19) United States
(12) Patent Application Publication
(10) Pub. No.: US 2006/0019232 A1
(43) Pub. Date: Jan. 26, 2006

(54) Modular bulletin board

(75) Inventors: Steven Fischer, Livingston, NJ (US); David Fischer, Bridgewater, NJ (US)

Correspondence Address: R. Neil Sudol, 714 Colorado Avenue, Bridgeport, CT, 06605-1601, US

(73) Assignee: VENTURE PRODUCTS, LLC, Fairfield, NJ (US)

(21) Appl. No.: 10/886,855

(22) Filed: Jul. 8, 2004

(51) Int. Cl. G09B 25/00

(52) U.S. Cl. 434/407

(57) ABSTRACT

A modular bulletin board includes a plurality of planar panels each having a plurality of edges. Each of the panels is provided along two or more contiguous edges with interleaved projections and recesses that interlock with recesses and projections on an adjacent panel. At least one adhesive element is provided for attaching a rear side of the panels to a surface. The panels have a front layer made of cork and a backing layer made of another material such as a polymeric foam material.

### BACKGROUND OF THE INVENTION

This invention relates to a display panel and an associated method. More particularly, this invention relates to a bulletin board and to an associated display method.

Display panels such as bulletin board generally come in fixed sizes that may or may not be suitable for the needs of the particular user. Boards that are too small do not adequately accommodate the user's needs as to the number and sizes of items that are to be posted on the boards. Boards that are too large cannot be fit into the space allotted.

Therefore, the need exists for a display board of a type that is easily adaptable to requirements of size.

### OBJECTS OF THE INVENTION

An object of the present invention is to provide an improved display panel.

Another object of the present invention is to provide a display panel having a size that can be varied in accordance with need or usefulness.

A further object of the present invention is to provide a display panel of modular construction.

An additional object of the present invention is to provide a display panel that may be mounted to a variety of different surfaces.

It is another object of the present invention to provide a display panel of simple and inexpensive construction.

It is yet another object of the present invention to provide a display method that is simple to use and readily adaptable to different applications and use requirements.

These and other objects of the present invention will be apparent from the drawings and descriptions herein. Although every object of the invention is believed to be attained by at least one embodiment of the invention, there is not necessarily any one embodiment that achieves all of the objects of the invention.

### SUMMARY OF THE INVENTION

A modular bulletin board comprises, in accordance with the present invention, a plurality of planar panels each having a plurality of edges. Each of the panels is provided along at least one edge with interleaved or alternating projections and recesses that interlock with recesses and projections on an adjacent panel. At least one connector element such as a magnet or an adhesive strip is provided for attaching a rear side of the panels to a surface.

Preferably, at least one of the panels is provided along at least two contiguous edges with interleaved or alternating projections and recesses that interlock with recesses and projections on adjacent panels. More preferably, at least one of the panels is rectangular or square and is provided along four edges with interleaved or alternating projections and recesses that interlock with recesses and projections on adjacent panels.

Preferably, but not necessarily, the panels each have a layer made of cork or glossy paperboard. The cork or paperboard layer may be a front layer, each of the panels having a backing layer made of another material such as a polymeric foam material. The connector element is attachable then to the backing layer.

Generally, it is contemplated that the panels are adhered to a vertical surface such as a wall, door, partition, mirror, or window, etc. The vertical surface may be made of any of a variety of materials, including wallboard, wood, sheet metal, plastic, glass, etc. The panels may be alternatively adhered to a horizontal surface such as a table or desk top.

In accordance with a particular embodiment of the present invention, where at least one of the panels is rectangular, with four edges each provided with projections and recesses that interlock with recesses and projections on an adjacent panel, it is contemplated that a plurality of the panels are provided with a single straight edge, whereas other panels (generally four in number) may be provided that have two contiguous straight edges and two contiguous edges provided with the interlocking projections and recesses. The latter panels serve as comer panels in an array of the panels assembled on or attached to a mounting surface.

In an alternative embodiment of the present invention, separate edge pieces may be provided. Each such edge piece has a straight edge on one side and a series of projections and recesses on an opposite side.

Preferably, the interlocking projections and recesses are dovetail-type projections and recesses.

Preferably, the connector elements are dual-sided adhesive strips.

A display method in accordance with the present invention utilizes a plurality of modular planar display panels each having a plurality of edges, each of the display panels being provided along at least one edge with interleaved or alternating projections and recesses. The panels are placed adjacent to and coupled with one another in part by interlocking projections and recesses on adjacent panels. In addition, the panels are attached to a mounting surface. A plurality of items are attached to a side of the coupled panels opposite the mounting surface.

The mounting surface is usually vertical and the items are attached to the interlocked display panels preferably by tacking the items to the panels. The tacking may be accomplished by using thumbtacks or staples. In this case the panels are made at least in part of a puncture-friendly material such as cork, styrofoam, paperboard, or rubber. Alternatively, particularly where the front faces of the panels are made of a hard material such as plastic or sheet metal, the items may be attached to the panels by adhesive, for instance, adhesive tape.

Where at least one of the panels is rectangular and has four edges, the coupling of the panels to one another may include coupling the one panel to at least four adjacent panels.

The coupling of the panels to one another may be executed at least in part prior to the adhering of the panels to the surface. Alternatively, a first panel may be adhered to the mounting surface prior to the coupling of any of the other panels to that first panel.

Typically, all of the panels are provided on the reverse sides with a connector element such as an adhesive strip. However, in some applications, depending in part on the panel size and the anticipated load, connector elements may be omitted from the rear sides of one or more of the panels.

The adhering of the panels to the surface may include attaching dual-sided adhesive strips to the panels and the surface. In that case, the dual-sided adhesive strips may be provided on at least one side with a releasable protective cover that is removed prior to adherence of the associated panel to the mounting surface.

A modular display panel assembly in accordance with the present invention provides a display panel with a size that can be varied in accordance with need or usefulness. This adaptability of the present display panel assembly and associated display method arises from the modular construction of the panels.

A display panel in accordance with the present invention may be mounted to a variety of different surface and is simple and inexpensive.

### BRIEF DESCRIPTION OF THE DRAWINGS

FIG. 1 is a schematic top plan view of a display panel piece of a modular display board assembly in accordance with the present invention.

FIG. 2 is a schematic cross-sectional view taken along line II-II in FIG. 1.

FIG. 3 is a schematic perspective view of a dual-sided adhesive strip utilizable to attach the panel of FIG. 1 to a mounting surface.

FIG. 4 is a schematic top plan view of another display panel piece of a modular display board assembly in accordance with the present invention.

FIG. 5 is a schematic top plan view of yet another display panel piece of a modular display board assembly in accordance with the present invention.

FIG. 6 is a schematic top plan view of an assembled modular display board in accordance with the present invention.

FIG. 7 is a partial top plan view of another assembled modular display board in accordance with the present invention, showing linear edge strips.

### DETAILED DESCRIPTION OF THE PREFERED EMBODIMENT

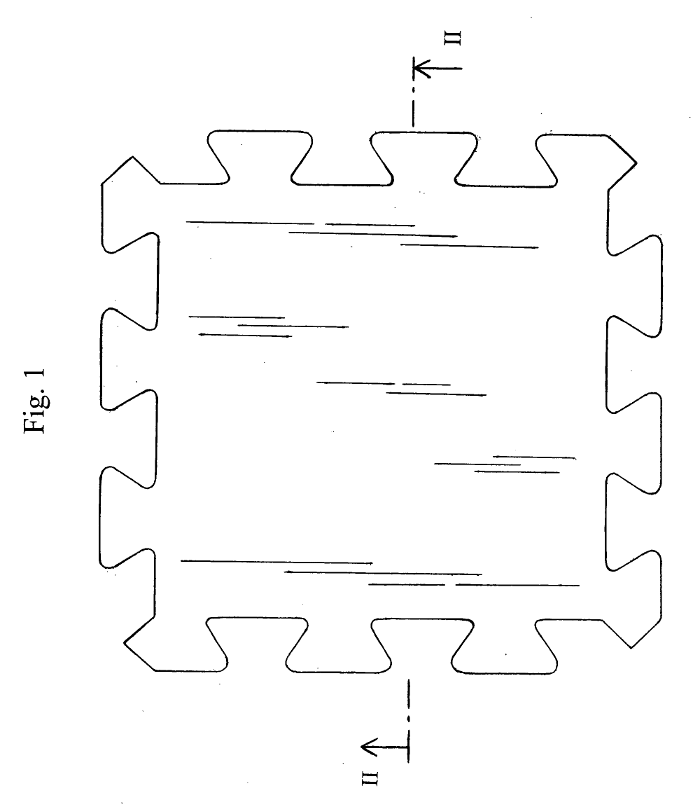

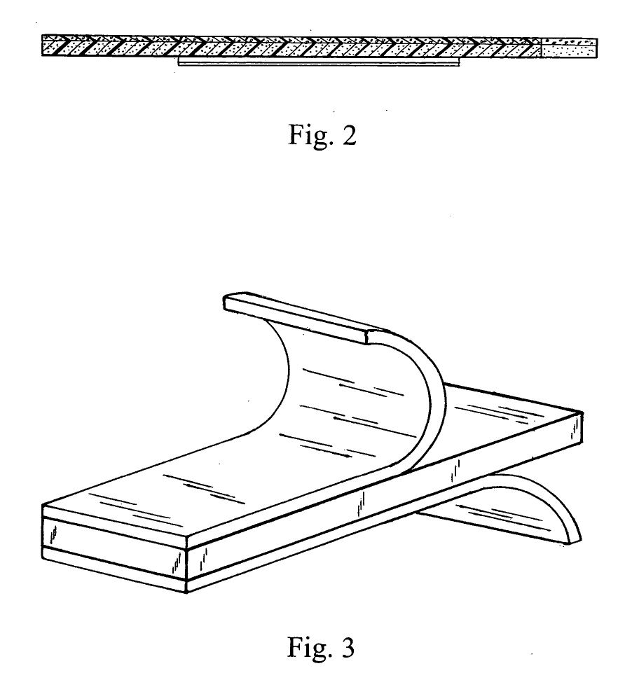

A modular bulletin board comprises at least one planar panel 10 illustrated in FIG. 1. Panel 10 has four contiguous edges 12 each provided with a plurality of interleaved or alternating dovetail-type projections 14 and recesses 15 that interlock with recesses and projections on an adjacent panel (see FIG. 5). As illustrated in FIG. 2, panel 10 may be provided on a rear surface 16 with at least one adhesive strip 18 for attaching the panel to a mounting surface such as a wall or door.

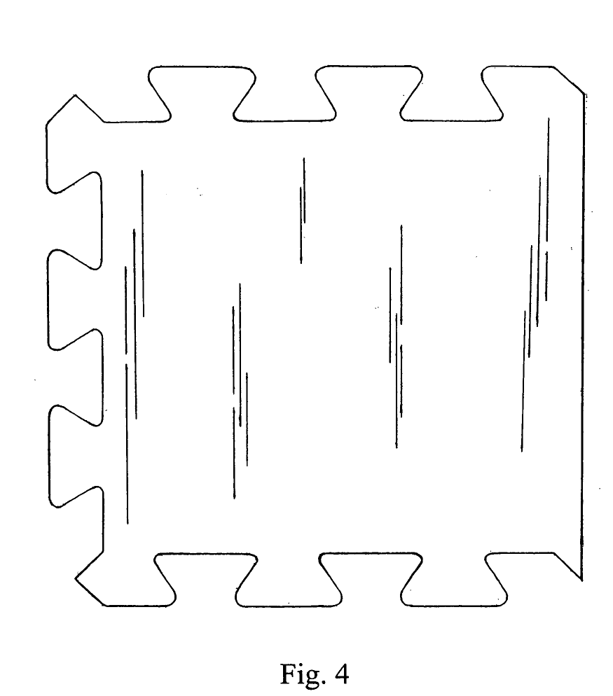

Panel 10 may be packaged for sale with adhesive strip 18 attached thereto. In that case, adhesive strip 18 is provided on an outer surface with a protective release strip 20 that is removed from strip 18 prior to the attachment of panel 10 to a mounting surface. Alternatively, panel 10 may be packaged for sale together with at least one dual-sided adhesive strip 22, as illustrated in FIG. 3, having opposite sides covered by protective release strips 24 and 26.

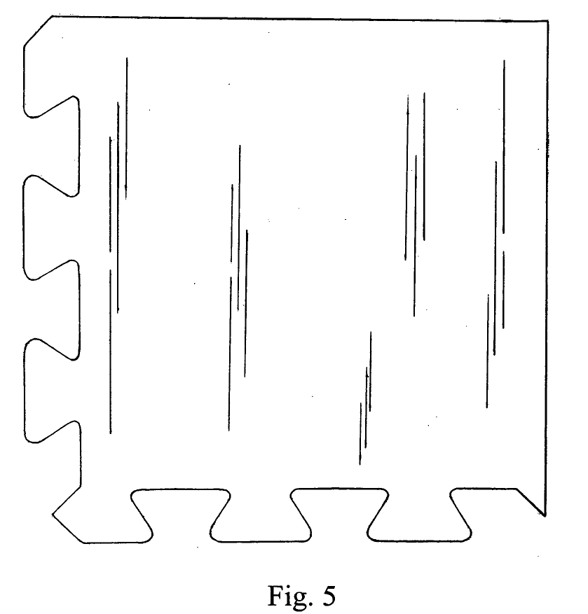

FIG. 4 depicts another planar panel 28 that may be sold together with or separately from panel 10 for cooperating therewith to form a display board having a straight edge. To that end, panel 28 has a single straight edge 30 and three contiguous crenulated edges 32. Edges 32 are each provided with a plurality of interleaved or alternating dovetail-type projections 34 and recesses 35 that interlock with recesses and projections on an adjacent panel (FIG. 5). As discussed above with reference to panel 10 and FIG. 2, panel 28 may be provided on a rear surface with at least one adhesive strip 18 for attaching the panel to a mounting surface such as a wall or door.

FIG. 5 depicts yet another planar display panel 36 that may be sold together with or separately from panels 10 and 28 for cooperating therewith to form a display board having a corner with straight edges. To that end, panel 36 has a pair of contiguous straight edges 38 and a pair of contiguous crenulated edges 40. Edges 40 are each provided with a plurality of interleaved or alternating dovetail-type projections 42 and recesses 43 that interlock with recesses and projections on an adjacent panel (FIG. 5). As discussed above with reference to panel 10 and FIG. 2, panel 36 may be provided on a rear surface with at least one adhesive strip 18 for attaching the panel to a mounting surface such as a wall or door.

As illustrated in FIG. 2, panels 10, 28 and 36 each have a front layer 44 made of cork or glossy paperboard and a backing layer 46 made of another material such as a polymeric foam material. Adhesive strip 18 or 22 is attachable then to a rear face of backing layer 46.

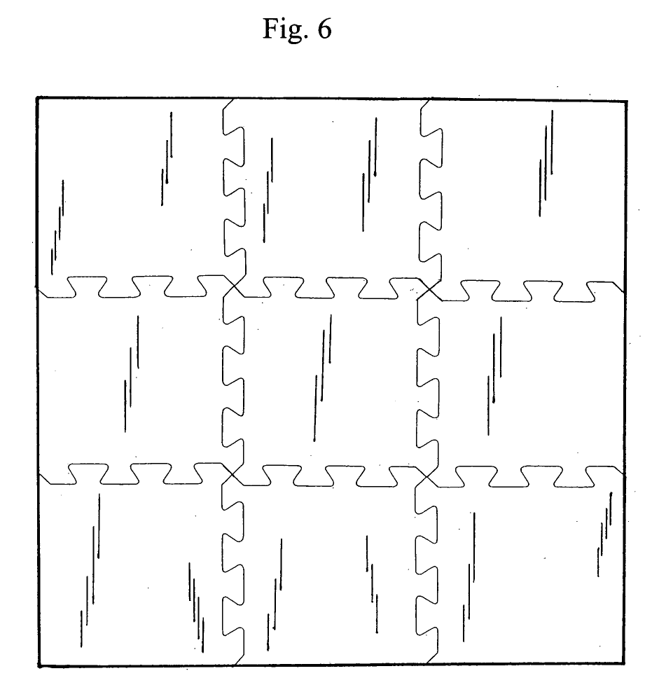

In use, a plurality of panels 10, 28, and 36 are placed adjacent to and coupled with one another in part by interlocking projections 14, 34, 42 and recesses 15, 35, 43 on adjacent panels. FIG. 6 depicts an illustrative configuration of panels 10, 28, and 36. It is to be understood, that different numbers of panels 10, 28, and 36 may be combined and connected in many alternative configurations that need not be rectangular. For example, display board having cross shapes (not shown) or step shapes are possible.

Panels 10, 28, and 36 may be assembled on a vertical or horizontal mounting surface (not shown) by first attaching one panel 10, 28, or 36 via an adhesive strip 18 or 22 to the mounting surface and subsequently coupling other panels 10, 28, and/or 36 in succession to the initial panel by sliding the respective dovetail projections 14, 34, 42 into respective recesses 15, 35, 43 to form an interlocked coupling. Prior to this sliding, the subsequently attached panels are preferably, but not necessarily, provided on their rear faces with respective adhesive strips 18 or 22 from which the protective cover strips 20, 24, 26 have been removed.

After a selected plurality of panels 10, 28, 36 are coupled to one another in a desired array on the mounting surface, various items are attached to the front faces of the coupled panels items for instance, by tacks or staples (not shown). Where the front layer 44 is made of glossy paperboard, a user may also be inclined to write on the front layer with an erasable (water-based) marker.

It is contemplated that the subsequently attached panels are coupled to the first panel on different occasions, so that the modular display board is incrementally increased in size and optionally in shape, depending on the needs and desires of the user. Thus, it is possible to market panels 10, 28, 36 separately, for instance, as additions to existing panel displays.

In an alternative method of building a display board, the coupling of panels 10, 28, 36 to one another may be executed at least in part prior to the adhering of any of the panels to the mounting surface.

Typically, all of the panels making up a display board are provided on the reverse sides with at least one adhesive strip 18 or 22. However, in some applications, depending in part on the panel size and the anticipated load, adhesive strips 18, 22 may be omitted from the rear sides of one or more panels 10, 28. 36.

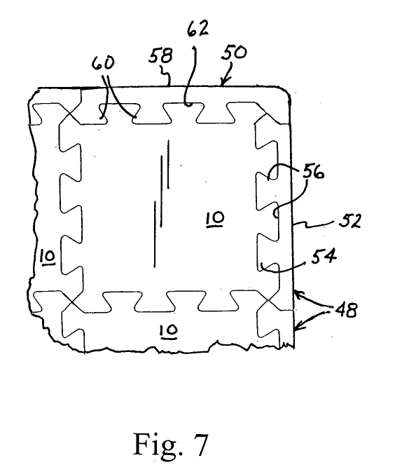

As illustrated in FIG. 7, a modular display panel assembly utilizing a number of main panels 10 may optionally include a plurality of edge strips 48 and corner strips 50. Edge strips 48 and corner strips 50 are elongate or narrow panels. Edge strips 48 are provided along one side with a straight edge 52 and on an opposing side with a crenellated edge comprising a plurality of interleaved projections 54 and recesses 56. Corner strips 50 are likewise provided along one side with a straight edge 58 and on an opposing side with a crenellated edge comprising a plurality of interleaved projections 60 and recesses 62. Corner strips 50 are each provided on at least one end with a corner formation 64 that generates a smooth corner profile for an assembled modular display panel.

The word “rectangular” as used herein denotes a quadrilateral with 90° angles between adjacent edges.

The term “dual-sided adhesive strip” is used herein to denote a planar piece of material provided along opposing major surface with adhesive layers.

The word “tack” or “tacking” is used herein to denote the insertion of one or more sharp connector elements through an item into a perforatable surface. The connector elements may take the form of tacks, staples, nails, pins, etc. The perforatable surface may be made of cork, cardboard, polymeric material, rubber, etc.

Although the invention has been described in terms of particular embodiments and applications, one of ordinary skill in the art, in light of this teaching, can generate additional embodiments and modifications without departing from the spirit of or exceeding the scope of the claimed invention. For example, the panels of a modular display board in accordance with the present invention may have a shape other than rectangular, such as triangular or hexagonal. Although polygonal shapes are preferred, non-polygonal shapes are possible, including shapes with curved edges.

Panels 28 and 36 may be omitted where crenellated edges are acceptable. Thus, a display board may use only panels 10. Alternatively, where smooth edges are desired, panels 28 and 36 may be replaced by elongate edge strips each provided on one side with a straight edge and on an opposing side with a crenellated edge having interleaved projections and recesses.

Adhesive strips 18 and 22 may be replaced with other forms of connector elements such as planar magnets.

Accordingly, it is to be understood that the drawings and descriptions herein are proffered by way of example to facilitate comprehension of the invention and should not be construed to limit the scope thereof.

What is claimed is:

1. A modular display board comprising:
a plurality of planar panels each having a plurality of edges, each of said panels being provided along at least one edge with interleaved or alternating projections and recesses that interlock with recesses and projections on an adjacent one of said panels; and
at least one connector element engageable with a rear side of said panels for attaching said panels to a surface.

2. The modular display board defined in claim 1 wherein said panels each have a layer made of material taken from the group consisting of cork and glossy paperboard.

3. The modular display board defined in claim 2 wherein said layer is a front layer, each of said panels having a backing layer made of a polymeric material.

4. The modular display board defined in claim 3 wherein at least one of said panels is rectangular and has four edges, said one of said panels being provided on each of said four edges with interleaved projections and recesses that interlock with recesses and projections on an adjacent one of said panels.

5. The modular display board defined in claim 4 wherein said projections and recesses are dovetail-type projections and recesses.

6. The modular display board defined in claim 3 wherein said backing layer is made of a polymeric foam material.

7. The modular display board defined in claim 1 wherein at least one of said panels is provided on at least two contiguous edges with interleaved or alternating projections and recesses that interlock with recesses and projections on an adjacent one of said panels.

8. The modular display board defined in claim 7 wherein each of said panels is provided on at least two contiguous edges with interleaved or alternating projections and recesses that interlock with recesses and projections on an adjacent one of said panels.

9. The modular display board defined in claim 1 wherein at least one of said panels is rectangular and has four edges, said one of said panels being provided on each of said four edges with interleaved projections and recesses that interlock with recesses and projections on an adjacent one of said panels.

10. The modular display board defined in claim 9 wherein another of said panels is rectangular and has four edges, said another of said panels being provided on each of said four edges with projections and recesses that interlock with recesses and projections on an adjacent one of said panels.

11. The modular display board defined in claim 1 wherein said connector element is taken from the group consisting of an adhesive strip and a magnet.

12. The modular display board defined in claim 11 wherein said connector element is a dual-sided adhesive strip.

13. The modular display board defined in claim 1 wherein said projections and recesses are dovetail-type projections and recesses.

14. The modular display board defined in claim 1, further comprising at least one elongate edge piece provided on one side with a straight edge and on an opposing side with interleaved or alternating projections and recesses that interlock with recesses and projections on an adjacent one of said panels.

15. A display method comprising:
providing a plurality of modular planar panels each having a plurality of edges, each of said panels being provided along at least one edge with interleaved or alternating projections and recesses;
placing said panels adjacent to one another;
coupling said panels to one another in part by interlocking projections and recesses on adjacent panels;
attaching said panels to a surface; and
attaching a plurality of items to a side of the coupled panels opposite said surface.

16. The display method defined in claim 15 wherein said surface is vertical.

17. The display method defined in claim 15 wherein the attaching of said items including tacking said items to said panels.

18. The display method defined in claim 15 wherein at least one of said panels is rectangular and has four edges, the coupling of said panels to one another including coupling said one of said panels to at least four adjacent panels.

19. The display method defined in claim 15 wherein the coupling of said panels to one another is executed prior to the adhering of said panels to said surface.

20. The display method defined in claim 15 wherein the coupling of said panels to one another is executed after at least one of said panels is adhered to said surface.

21. The display method defined in claim 15 wherein said panels have a front-facing layer made of a material taken from the group consisting of cork and glossy paperboard, the attaching of said items including tacking said items to said panels.

22. The display method defined in claim 15 wherein the attaching of said panels to said surface includes attaching adhesive strips or magnets to said surface.

23. A display board comprising:
at least one planar panel having a plurality of edges, said at least one panel being provided along at least one edge with interleaved or alternating projections and recesses that interlock with recesses and projections on another panel; and
at least one connector element engageable with a rear side of said at least one panel for attaching said panels to a surface.
